(19) United States
(12) Patent Application Publication
(10) Pub. No.: US 2014/0300101 A1
(43) Pub. Date: Oct. 9, 2014

(54) Method and Apparatus for Connecting a Hose to a Fitting

(71) Applicant: Larry F. Bobenhausen, St. Petersburg, FL (US)

(72) Inventor: Larry F. Bobenhausen, St. Petersburg, FL (US)

(21) Appl. No.: 13/855,817

(22) Filed: Apr. 3, 2013

(51) Int. Cl. F16L 33/207

(52) U.S. Cl. CPC F16L 33/2071
USPC 285/242

(57) ABSTRACT

A clamp guide for joining a flexible hose to a rigid, hollow shaft has an arced first bump for interfacing with a head bead of at least two beads of the rigid, hollow shaft and has two legs. The legs extend from ends of the arced first bump, each having at least one bump aligned with subsequent beads of the at least two beads thereby forming registration areas between adjacent bumps. At least one lateral support extends from at least one of the legs at an edge of the legs at the registration area. Each of the lateral supports has a shape of a segment of a cylinder having an inner diameter approximately equal to an outer diameter of the flexible hose.

### FIELD OF THE INVENTION

This invention relates to a method for connecting a hose to a fitting. More particularly, it refers to a method and apparatus for connecting a hose to a fitting using one or more clamps and using a clamp guide.

### BACKGROUND

Air conditioning hose assembly connection systems are known. The simplest is to fit an end of a flexible, compressible hose over a metal fitting or stem and attaching clamps on the hose over the fitting to hold the hose to the fitting and to prevent leaks in various applications such as with high pressure refrigerants. Often, this is not sufficient for such high pressure connections because the hose tends to slip off the fitting. To improve this type of connection, the fitting is made with one or more beads that help hold the hose to the fitting. Still, in high-pressure applications, it is still possible for the hose to come free from the fitting.

To further improve the connection, guides have been deployed to guide the installation of the clamps such that the clamps situate themselves between the beads, making it even more difficult for the hose to slip off of the fitting.

What is needed is a guide that aligns the clamps between the beads that reduces skewing of the cable guides and clamps to better hold the hose to the fitting.

### SUMMARY OF THE INVENTION

The invention includes a method of joining a flexible hose to a rigid, hollow shaft. The rigid, hollow shaft has a groove, a head bead adjacent to the groove, and at least one bead (a bead that will be positioned beneath the hose). The method includes the steps of providing a flexible hose, a first end of the flexible hose cut at 90 degrees with respect to an axis of the flexible hose and (b) providing a clamp guide. The clamp guide has an arced surface for interfacing with the groove and two legs. Each of the legs has at least two bumps, each bump corresponding to and aligned with each bead, thereby forming registration areas between adjacent bumps. At least one lateral support extends from an edge of at least one of the legs at the registration area. Each of the lateral support(s) has a shape of a segment of a cylinder, the segment of the cylinder having an inner diameter approximately equal to the outer diameter of the flexible hose. The method continues with (c) placing at least one hose clamp loosely over the flexible hose then (d) pushing the first end of the flexible hose over the rigid, hollow shaft, the first end of the flexible hose abutting the head bead. The clamp guide is then attached (e) by interfacing the arced surface with the groove and resting the clamp guide arms against the flexible hose. Next, each of the hose clamps are positioned (f) over each of the registration areas and (g) the hose clamps are tightened, thereby compressing the flexible hose between the hose beads.

In another embodiment, a method of joining a flexible hose to a rigid, hollow shaft is disclosed. The rigid, hollow shaft has three beads, a first head bead, a second bead, and a third bead, wherein the second bead and third bead are on one side of the head bead and the third bead is further from the head bead than the second bead. (a) A flexible hose is provided and has a first end cut at 90 degrees with respect to an axis of the flexible hose. A clamp guide is provided (b). The clamp guide has an arced first bump for interfacing with a head bead, and two legs. The legs extend from the arced first bump and each leg has a second bump aligned with a second bead and a third bump aligned with the third bead thereby forming a first registration area between the first bump and the second bump and forming a second registration area between the second bump and the third bump. At least one lateral support extends from at least one of the legs at an edge of the leg(s) at the registration areas. Each of the lateral supports has a shape of a segment of a cylinder, the segment of the cylinder having an inner diameter approximately equal to the outer diameter of the flexible hose; The next step is (c) placing two hose clamps loosely over the flexible hose. Next, (d) pushing the first end of the flexible hose over the rigid, hollow shaft, the first end of the flexible hose abutting the head bead then (e) attaching the clamp guide by interfacing the arced first bump with the head bead and resting the clamp guide arms and lateral support(s) against the flexible hose. A first hose clamp of the two hose clamps is positioned (f) over the first registration (between the first bump and the second bump) and a second hose clamp of the two hose clamps is positioned (g) over the second registration (between the second bump and the third bump). The first and second hose clamp are tightened (h), thereby compressing the flexible hose between the beads.

In another embodiment, a clamp guide for joining a flexible hose to a rigid, hollow shaft is disclosed. The rigid, hollow shaft has at least two beads, the clamp guide has an arced first bump for interfacing with a head bead of the at least two beads and has two legs. The legs extend from ends of the arced first bump, each having at least one bump aligned with subsequent beads of the at least two beads thereby forming registration areas between adjacent bumps. At least one lateral support extends from at least one of the legs at an edge of the legs at the registration area. Each of the lateral supports has a shape of a segment of a cylinder having an inner diameter approximately equal to an outer diameter of the flexible hose.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a guide of the prior art.

FIG. 2 illustrates a sectional view of a guide of the prior art.

FIG. 3A illustrates a perspective view of an improved clamp guide.

FIG. 3B illustrate an end plan view of the improved clamp guide.

FIG. 3C illustrate a top plan view of the improved clamp guide.

FIG. 3D illustrate a bottom plan view of the improved clamp guide.

FIG. 4 illustrates a perspective view of the improved clamp guide as it attaches to a hose and fitting.

FIG. 5 illustrates a perspective view of the improved clamp guide attached to a hose and fitting before adding claims.

FIG. 6 illustrates a perspective view of the improved clamp guide attached to a hose and fitting after adding claims.

FIG. 7 illustrates a perspective view of a hose connecting two fittings using the improved clamp guide and clamps.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

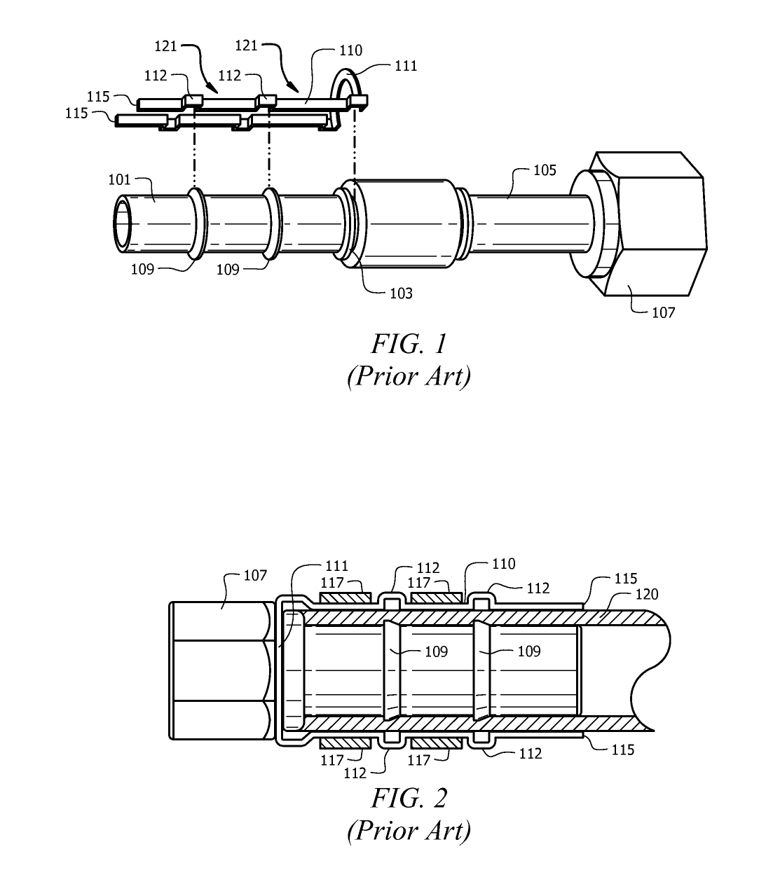

Referring to FIG. 1 and FIG. 2, a perspective view and a plan view of a clamp guide 110 of the prior art is shown. The prior art for connecting a flexible hose 120 to a rigid, hollow shaft 101/105 includes a clamp guide 110 as shown in FIG. 1. The clamp guide 110 has registrations 121 between ridges 112 that align with beads 109 on a hose-connection end 101 of the rigid, hollow shaft 101/105. The clamp guide 110 has a semi-circular portion 111 that fits inside a groove 103 in the rigid hollow shaft 101/105 so that the clamp guide arms 115 are on exactly opposite sides of the flexible hose 120 when the flexible hose 120 is positioned over the receiving end 101 of the rigid, hollow shaft 101/105. The rigid, hollow shaft 101/105 is anticipated to be a component of a variety of connectors and fittings, one example is shown having a threaded fitting 107 at an end 105 distal from where a flexible hose 120 is attached using the clamp guide 110 and clamps 117.

As pressure increases, using the clamp guides 110 and claims 117 of the prior art, the hose 120 tends to pull off of the shaft 101 of the fitting, deforming the clamp guide 110 and skewing the arms 115 of the clamp guide 110 until the hose eventually pulls off of the shaft 101 of the fitting.

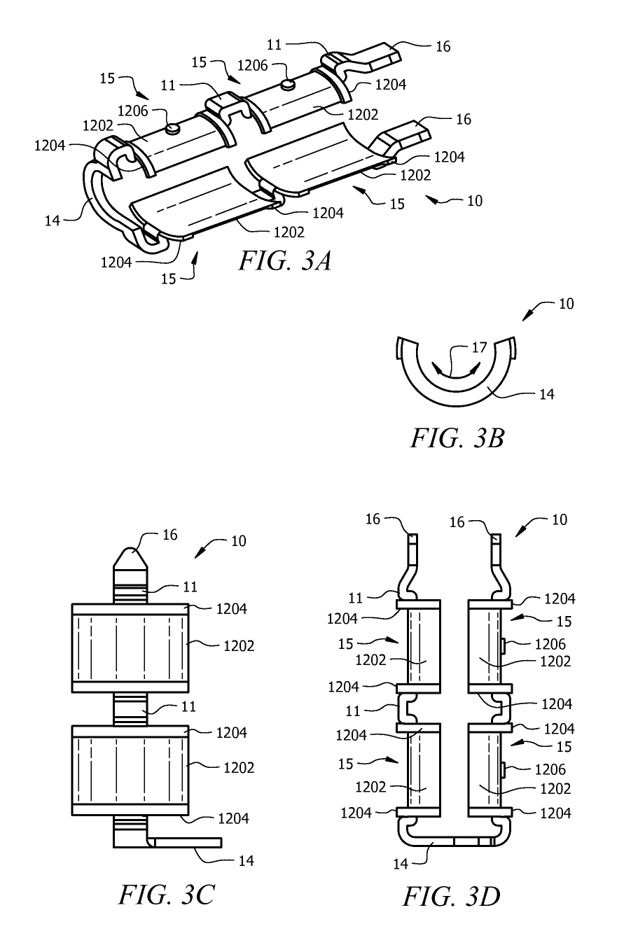

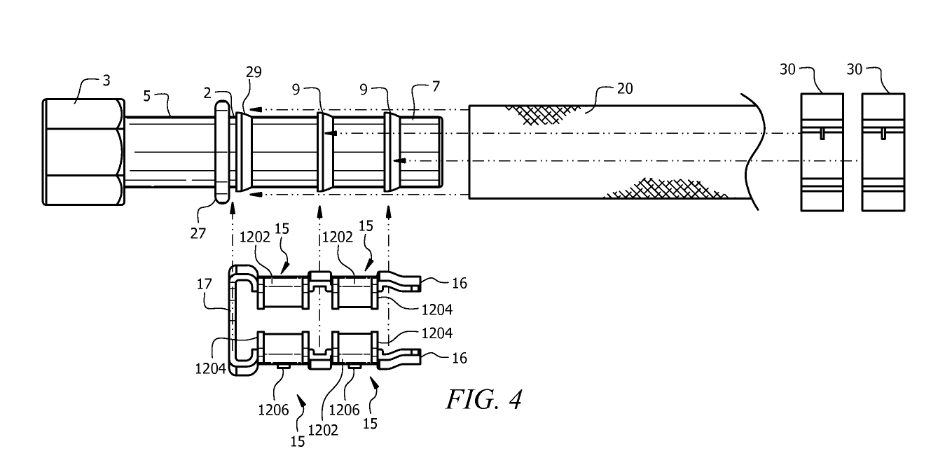

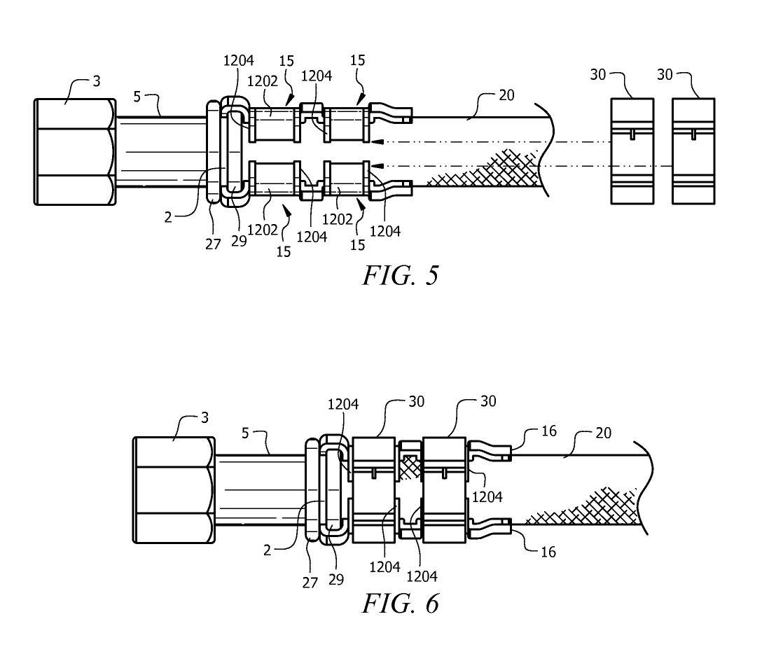

Referring to FIG. 3A-D, views of the improved clamp guide 10 are shown. The clamp guide 10 includes two clamp guide arms 16 attached to each other by an arc 14 that has an inner edge 17 that, in some embodiments, is greater than 180 degrees and less than 360 degrees. In such embodiments, the inner surface 17 of the arc 14 has an inner diameter that is approximately the same or slightly greater than an outer diameter of the hollow shaft 2 (see FIG. 4) where it rests. Also, in such embodiments, the circumferential length of the inner surface 17 of the arc 14 is greater than one half of the outer circumference of the rigid, hollow shaft 2 (see FIG. 4). Being such, as the hose clamps 30 (see FIGS. 5 and 6) are tightened around the flexible hose 20, the flexible hose 20 compresses around the hose end 7 of the rigid hollow shaft 5/7 and the arc 14 is pulled tighter around the rigid, hollow shaft 5/7, thereby forming a stronger bond between the fitting/connector 3/5/7 and the flexible hose 20. Any known types of hose clamps 30 are anticipated.

In some embodiments, the arc 14 is interfaced with a groove 2 while in other embodiments, there is no groove 2 (e.g., groove bead 27 is absent) and the arc 14 is interfaced with a head bead 29.

There are several beads 9/29/27 on the hollow rigid shaft 5/7. The bead 9/29/27 that aligns with the arc 17 is the head bead 29. The groove bead 27 is present in some embodiments to form the groove 2 between the groove bead 27 and the head bead 29.

The clamp guide arms 16 have bumps 11 that align with the beads 9 (see FIG. 4) and registration areas 15 that are aligned between the beads 9. The hose clamps 30 (see FIG. 5-7) are placed over the clamp guide arms 16 such that the hose clamps 30 seat into the registration areas 15. In this way, as the hose clamps 30 are tightened, the flexible hose 20 is compressed in between the beads 9, providing a stronger connection between the flexible hose 20 and the rigid, hollow shaft 5/7, thereby resisting separation under high pressure.

Although two registration areas 15 are shown, the present invention is not limited to any particular number of registration areas 15 and any number of registration areas 15 is anticipated including one registration area 15.

It is preferred to fabricate the clamp guide arms 16 from a stiff, sturdy metal such as steel.

The improved clamp guide 10 has one or more lateral supports 1202 extending from the legs 16 in the registration areas 15. The lateral supports 1202 are curved to follow the outer diameter of the intended hose 20 such that, when the clamps 30 are placed in the registration areas, the lateral supports 1202 are positioned beneath the clamps and, as the clamps are tightened, the lateral supports 1202 are pressed onto the surface of the hose 20, thereby holding the legs 16 of the improved clamp guide 10 from twisting and/or deforming. Although two lateral supports 1202 are shown extending from each registration area 15, any number of lateral supports 1202 is anticipated in any configuration. For example, in some embodiments, there are multiple registration areas and only one registration area has two lateral supports, while in another embodiment, one registration area 15 has two lateral supports 1202 and another registration area 15 has no lateral supports 1202. Likewise, in some embodiments, there are mixed numbers of lateral support 1202, for example, one registration area 15 has one lateral supports 1202 on a first side of the leg 16 and another registration area 15 has one lateral supports 1202 on an opposing side of the leg 16.

The lateral supports 1202 are preferably formed/cut from the same material as the legs 16 and are preferably bent/formed during the manufacturing process. The lateral supports 1202 are in the shape of a segment of a cylinder having an inner diameter approximately the same as an outer diameter of the target hose 20.

Although not required, in some embodiments, a rim 1204 is formed along one or both edges of the lateral supports, thereby defining a contained area in which the clamp 30 will rest.

Although not required, in some embodiments, a clamp alignment nub 1206 is formed on one of the clamp legs 16, preferably approximately central to the registration areas 15. The claim alignment nub 1206 forces the head of the clamp 30 to be correctly positioned over the clamp alignment nub 1206.

Referring to FIG. 4-6, plan views of the present invention as it attaches to a hose is shown. In FIG. 4, the flexible hose 20 is shown cut at 90 degrees and is ready to be pushed over the connection end 7 of the rigid, hollow shaft 5/7. To facilitate connection, two hose clamps 30 are placed loosely over the flexible hose 20, typically before the flexible hose 20 is pushed over the connection end 7. The improved clamp guide 10 is shown ready to be placed over the flexible hose 20, the arc 17 of which is positioned to interface with the groove 2 (or the head bead 29) of the hollow shaft 5/7, thereby aligning the registrations 15 with the spaces between the beads 9.

In FIG. 5, the clamp guide 10 is on the flexible hose 20, and the arc 17 of the clamp guide 10 is interfaced with the groove 2 or head bead 29 of the rigid, hollow shaft 5/7. The clamps have not been positioned into the registration areas 15. The lateral supports 1202, having an internal diameter approximately equal to the outer diameter of the hose 20, rest on the hose 20 with little or no gap between the hose 20 and the lateral supports 1202.

In FIG. 6, the hose clamps 30 are positioned in the registration areas 15 and tightened, thereby forming a strong bond between the flexible hose 20 and the rigid, hollow shaft 5/7. Although shown with a threaded fitting 3 at one end, any type of fitting/connection is anticipated including a second groove 2 and any number of beads 9 for joining to flexible hoses 20. The clamps 30 are positioned and held between the optional rims 1204 of the lateral supports 1202. As the clamps 30 are tightened, the clamps 30 apply pressure over the registration areas 15 and the lateral supports 1202 and evenly compress the hose 20 in an area between the beads 9/29 (not visible in FIG. 6).

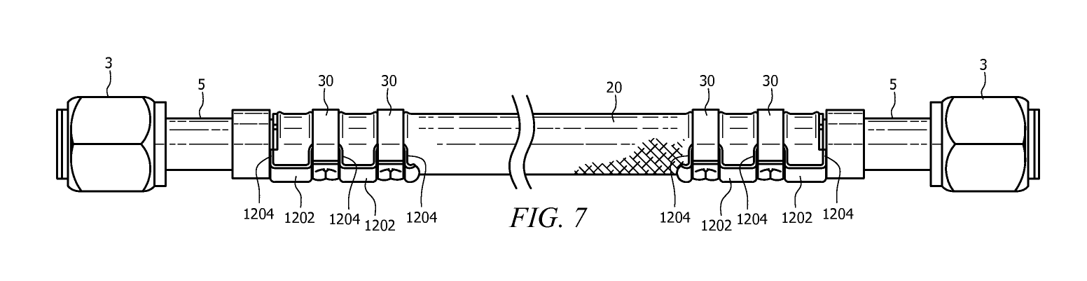

Referring to FIG. 7, of a perspective view of a hose 20 connecting two fittings using the improved clamp guide 10 and clamps 30 is shown. The hose clamps 30 are positioned in the registration areas 15 and tightened, thereby forming a strong bond between the flexible hose 20 and the rigid, hollow shaft 5/7. Although shown with a threaded fitting 3 at one end, any type of fitting/connection is anticipated including a second groove 2 and any number of beads 9 for joining to flexible hoses 20. The clamps 30 are positioned and held between the optional rims 1204 of the lateral supports 1202. As the clamps 30 are tightened, the clamps 30 apply pressure over the registration areas 15 and the lateral supports 1202 and evenly compress the hose 20 in an area between the beads 9/29 (not visible in FIG. 7). If present, the nubs 1206 (not visible) are located on the legs 16, approximately central to the registration area 15. The clamps 30, having some amount over clearance beneath the clamp ears, fit in the registration area only when the ear of the clamp aligns with the nub 1206, thereby assuring proper rotational location of the clamp 30.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of joining a flexible hose to a rigid, hollow shaft, the rigid, hollow shaft having at head bead and at least on other beads and a groove, the steps comprising:
(a) providing a flexible hose, a first end of the flexible hose cut at 90 degrees with respect to an axis of the flexible hose;
(b) providing a clamp guide, the clamp guide having an arced surface for interfacing with the groove, the clamp guide having two legs, the legs having at least two bumps, each bump corresponding to and aligned with each bead, the bumps forming registration areas between adjacent bumps, at least one lateral support extending from an edge of at least one of the legs at the registration area, each of the at least one lateral support having a shape of a segment of a cylinder, the segment of the cylinder having an inner diameter approximately equal to the outer diameter of the flexible hose;
(c) placing at least one hose clamp loosely over the flexible hose;
(d) pushing the first end of the flexible hose over the rigid, hollow shaft, the first end of the flexible hose abutting a head bead of the at least two beads;
(e) attaching the clamp guide by interfacing the arced surface with the head bead and resting the legs and at least one lateral support against the flexible hose;
(f) positioning each of the hose clamps over the each of the registration areas; and
(g) tightening the hose clamps, thereby compressing the flexible hose between the at least two beads.

2. The method of claim 1, wherein the arced surface arcs at greater than 180 degrees and less than 360 degrees and each of the legs are located at respective ends of the arced surface, thereby the legs are biased to one side of the rigid, hollow shaft.

3. The method of claim 1, wherein the at least two beads is exactly two beads, the at least two bumps is exactly two bumps and the registration areas is exactly one registration area with two lateral supports, each lateral support of the two lateral supports extend from opposing edges of one of the legs at the registration area, and whereas the step (f) of positioning includes positioning one hose clamp over the one registration and lateral supports.

4. The method of claim 1, wherein the at least two beads is exactly three beads, the at least two bumps is exactly three bumps and the registration areas is exactly two registration areas with four lateral supports, each lateral support of the four lateral supports extends from opposing edges of one of the legs at the registration areas and whereas the step (f) of positioning includes positioning a first of the hose clamps over two of the lateral supports at a first registration area of the two registration areas and positioning a second of the hose clamps over a second two of the lateral supports at a second registration area of the two registration areas.

5. The method of claim 1, wherein the rigid, hollow shaft further includes at least one o-ring groove between the at least two beads and each of the at least one o-ring grooves is fitted with an o-ring.

6. The method of claim 1, where the rigid, hollow shaft is part of a threaded fitting.

7. The method of claim 1, wherein the rigid, hollow shaft further includes a groove bead forming a groove between the groove bead and the head bead and the arced surface interfaces with the groove.

8. The method of claim 1, wherein the clamp guide is stamped and formed from a sheet of steel.

9. A method of joining a flexible hose to a rigid, hollow shaft, the rigid, hollow shaft having three beads, a head bead, a second bead, and a third bead, wherein the second bead and third bead are on one side of the head bead and the third bead is further from the head bead than the second bead, the steps comprising:
(a) providing a flexible hose, a first end of the flexible hose cut at 90 degrees with respect to an axis of the flexible hose;
(b) providing a clamp guide, the clamp guide having an arced first bump for interfacing with the head bead, the clamp guide having two legs, the legs extending from the arced first bump, each of the legs have a second bump aligned with a second bead and a third bump aligned with the third bead thereby forming a first registration area between the head bump and the second bump and forming a second registration area between the second bump and the third bump, and at least one lateral support extends from at least one of the legs at an edge of at least one of the legs at the registration areas, each of the at least one lateral supports having a shape of a segment of a cylinder, the segment of the cylinder having an inner diameter approximately equal to the outer diameter of the flexible hose;
(c) placing two hose clamps loosely over the flexible hose;
(d) pushing the first end of the flexible hose over the rigid, hollow shaft, the first end of the flexible hose abutting the head bead;
(e) attaching the clamp guide by interfacing the arced first bump over the head bead and resting the clamp guide legs and lateral supports against the flexible hose;
(f) positioning a first hose clamp of the two hose clamps over the first registration;
(g) positioning a second hose clamp of the two hose clamps over the second registration; and
(h) tightening the first and second hose clamp, thereby compressing the flexible hose between the at least one bead.

10. The method of claim 8, wherein the arced first bump has an inner diameter equal to an outer diameter of the head bead, the arced first bump an inner circumferential length greater than one half of the circumference of the head bead and the inner circumferential length is less than the circumference of the head bead and each of the two legs are at opposing ends of the arced first bump, thereby biasing the two legs to one side of the head bead.

11. The method of claim 8, wherein the hollow shaft further includes at least one o-ring groove between two of the three beads and each of the at least one o-ring grooves is fitted with an o-ring.

12. A clamp guide for joining a flexible hose to a rigid, hollow shaft, the rigid, hollow shaft having at least two beads, the clamp guide comprising:
an arced first bump for interfacing with a head bead of the at least two beads, the clamp guide having two legs, the legs extending from the arced first bump, each of the legs have at least one bump aligned with subsequent beads of the at least two beads thereby forming registration areas between adjacent bumps; and
at least one lateral support extends from at least one of the legs at an edge of at least one of the legs at the registration areas, each of the at least one lateral supports having a shape of a segment of a cylinder, the segment of the cylinder having an inner diameter approximately equal to an outer diameter of the flexible hose.

13. The clamp guide of claim 12, wherein the arced first bump arcs at greater than 180 degrees and less than 360 degrees and each of the legs are located at respective ends of the arced first bump, thereby the legs are biased to one side of the rigid, hollow shaft.

14. The clamp guide of claim 12, wherein the at least two beads is exactly two beads, the at least two bumps is exactly two bumps and the registration areas is exactly one registration area with two lateral supports, each lateral support of the two lateral supports extend from opposing edges of one of the legs at the registration area.

15. The clamp guide of claim 12, wherein the at least two beads is exactly three beads, the at least two bumps is exactly three bumps and the registration areas is exactly two registration areas with four lateral supports, each lateral support of the four lateral supports extends from opposing edges of one of the legs at the registration areas.

16. The clamp guide of claim 12, wherein the rigid, hollow shaft further includes at least one o-ring groove between the at least two beads and each of the at least one o-ring grooves is fitted with an o-ring.

17. The clamp guide of claim 12, where the rigid, hollow shaft is part of a threaded fitting.

18. The clamp guide of claim 12, wherein the rigid, hollow shaft further includes a groove bead forming a groove between the groove bead and the head bead and the arced surface interfaces with the groove.

19. The clamp guide of claim 12, wherein the clamp guide is stamped and formed from a sheet of steel.

20. The clamp guide of claim 12, further comprising a nubs formed on one of the legs, the nubs extending outwardly from the legs at a location substantially central to each of the registration areas.
